(19) United States
(12) Patent Application Publication
(10) Pub. No.: US 2024/0122384 A1
(43) Pub. Date: Apr. 18, 2024

(54) INFLATABLE PILLOW DECORATION DEVICE

(71) Applicants: Darrell Nelson, N. Hollywood, CA (US); Erica Lee, N. Hollywood, CA (US)

(72) Inventors: Darrell Nelson, N. Hollywood, CA (US); Erica Lee, N. Hollywood, CA (US)

(21) Appl. No.: 17/966,326

(22) Filed: Oct. 14, 2022

(51) Int. Cl. A47G 9/10

(52) U.S. Cl. CPC A47G 9/1027

(57) ABSTRACT

An inflatable pillow decoration device for use only as a decoration includes a pillow having an exterior wall enclosing an interior space. The interior space is in fluid communication with an opening extending through the exterior wall of the pillow. The exterior wall further includes an inner layer bounding the interior space, a middle layer being resiliently compressible, and an outer layer being coupled to the middle layer. An inflation apparatus is positioned in the opening and is in fluid communication with the interior space. The inflation apparatus inflates the interior space and to warms the air being supplied to the interior space by the inflation apparatus.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pillow device and more particularly pertains to a new pillow device for use only as a visual decoration.

### (2) Description of Related Art Including Information Disclosed Under 37 CFR 1.97 and 1.98

The prior art relates to pillow devices. Known prior art includes a variety of pillow devices having a cushion material and an interior space. Known prior art lacks a pillow device being configured for inflating by heated air and being used as a visual decoration.

### BRIEF SUMMARY OF THE INVENTION

An embodiment of the disclosure meets the needs presented above by generally comprising a pillow having an exterior wall enclosing an interior space. The interior space is in fluid communication with an opening extending through the exterior wall of the pillow. The exterior wall further comprises an inner layer bounding the interior space, a middle layer being positioned on the inner surface and being resiliently compressible, and an outer layer being coupled to the middle layer. An inflation apparatus is positioned in the opening and is in fluid communication with the interior space. The inflation apparatus is configured to inflate the interior space and to warm air being supplied to the interior space by the inflation apparatus.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric in-use view of an inflatable pillow decoration device according to an embodiment of the disclosure.

FIG. 2 is a front view of an embodiment of the disclosure.

FIG. 3 is a bottom view of an embodiment of the disclosure.

FIG. 4 is a cross-sectional view of an embodiment of the disclosure taken from FIG. 3 of Line 4-4.

FIG. 5 is a block diagram view of an embodiment of the disclosure.

### DETAILED DESCRIPTION OF THE INVENTION

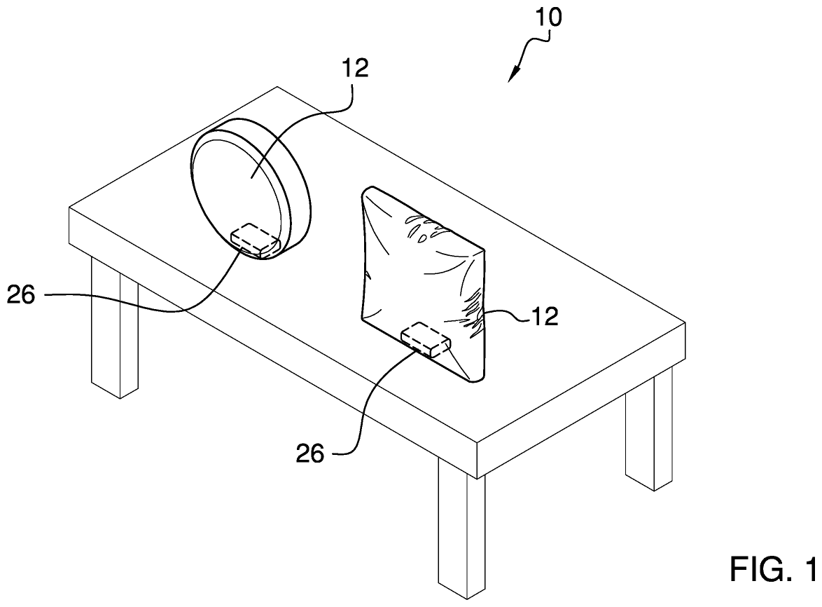

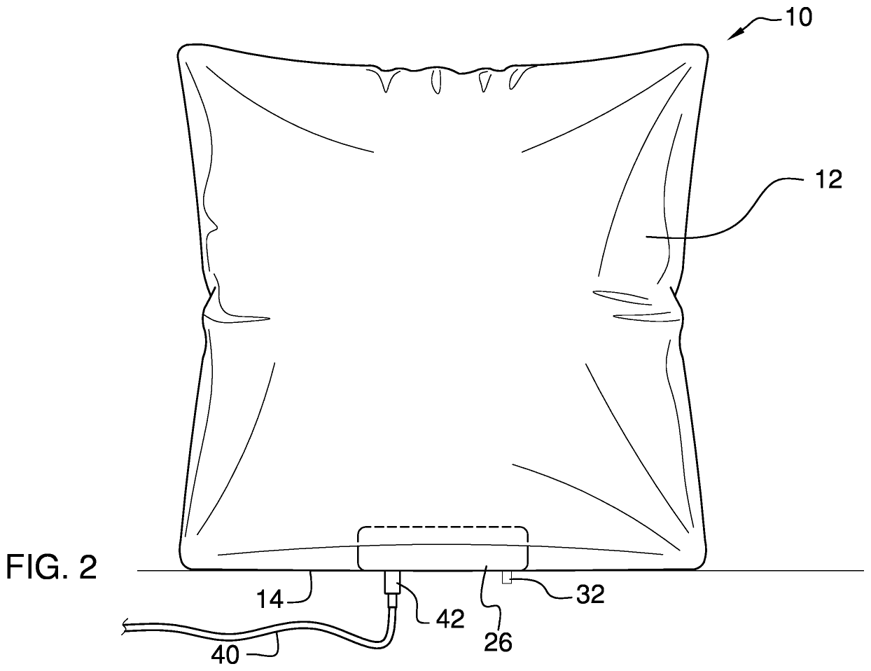

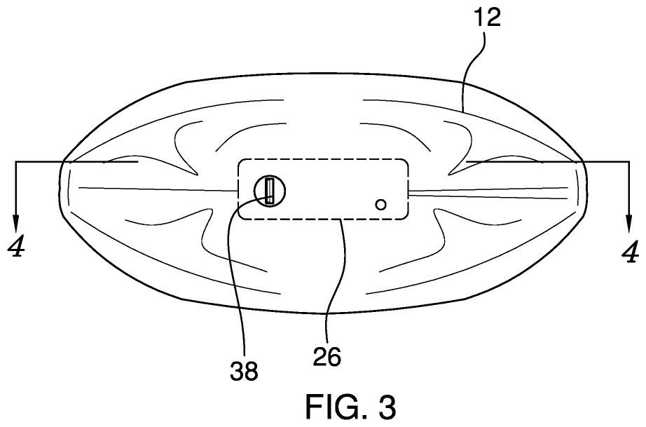

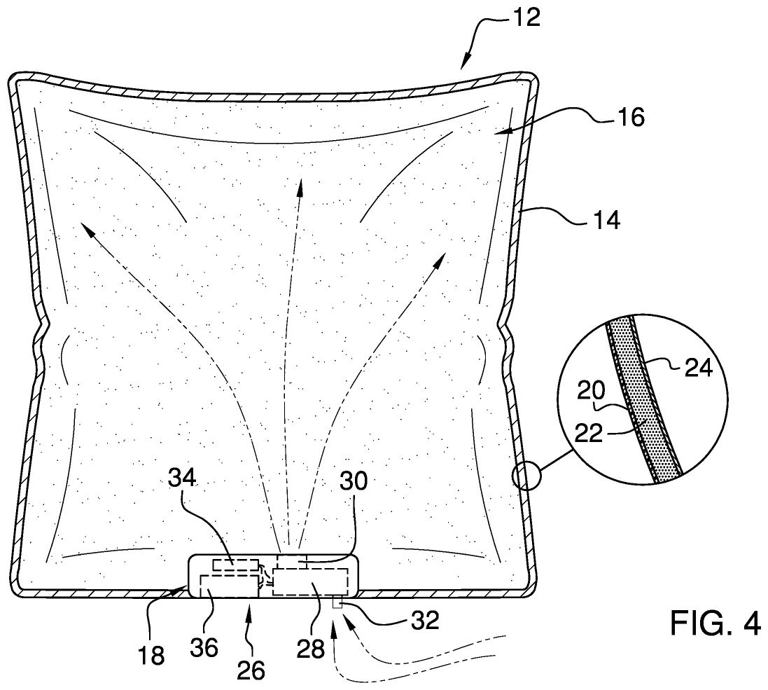

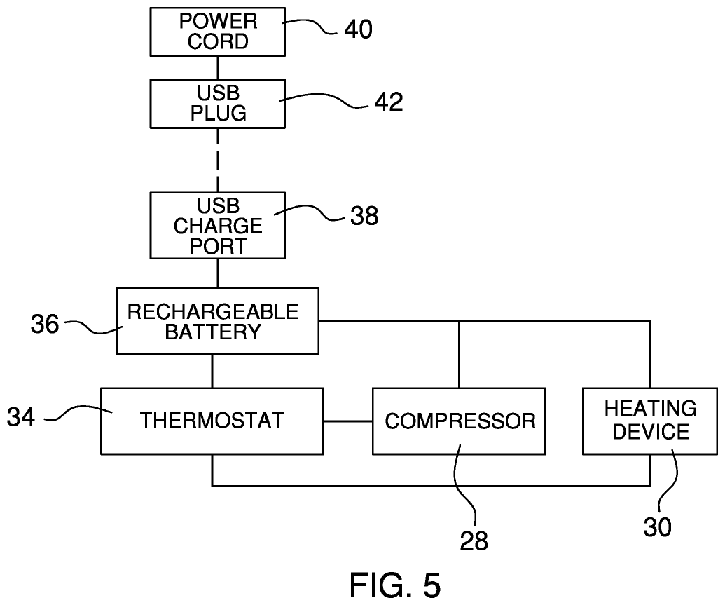

With reference now to the drawings, and in particular to FIGS. 1 through 5 thereof, a new pillow device embodying the principles and concepts of an embodiment of the disclosure and generally designated by the reference numeral 10 will be described.

As best illustrated in FIGS. 1 through 5, the inflatable pillow decoration device generally comprises a pillow 12 having an exterior wall 14 enclosing an interior space 16. The interior space 16 is in fluid communication with an opening 18 extending through the exterior wall 14 of the pillow 12. The exterior wall 14 further comprises an inner layer bounding the interior space 16. The inner layer 20 comprises a heat resistant material being configured for having a higher thermal index relative to the fluid within the interior space 16. The inner layer 20 is air impermeable such that the inner layer 20 retains air within the interior space 16. A middle layer 22 is positioned on the inner layer 20 and is resiliently compressible. The middle layer 22 is a plush material being compressible and supple. An outer layer 24 is coupled to the middle layer 22. The outer layer 24 is a silk material being configured for feeling smooth relative to the touch of the user.

An inflation apparatus 26 is positioned in the opening 18 and is in fluid communication with the interior space 16. The inflation apparatus 26 is configured to inflate the interior space 16 and to warm the air being supplied to the interior space 16 by the inflation apparatus 26. The inflation apparatus 26 will most often be weighted such that the inflation apparatus 26 is configured for standing the pillow 12 in an upright position when the pillow 12 is inflated. The inflation apparatus 26 includes an air compressor 28 being in fluid communication with the interior space 16 of the pillow 12. The air compressor 28 is configured for injecting air into the interior space 16 of the pillow 12 and retaining the air within the interior space 16. A heating source 30 is in thermal communication with an air conduit 32 of the air compressor 28. The heating source 30 is an electric heater configured for warming the fluid within the air conduit 32 and is positioned proximate to the inside surface of the inflation apparatus 26.

A thermostat 34 is electrically coupled to the heating source 30 and is adjustable to select a temperature of the air positioned in the interior space 16. A power supply 36 is electrically coupled to the air compressor 28 and the heating source 30 and is configured for providing electricity to the inflation apparatus 26. The power supply 36 is rechargeable and has a port 38 being a universal serial bus port positioned on the outside surface of the inflation apparatus 26.

In use, a plug 42 being a universal serial bus input from a power cord 40 is inserted into the port 38 of the inflation apparatus 26 of the pillow 12 and provides electricity to the power supply 36. The inflation apparatus 26 is actuated to inflated the interior space 16 of the pillow 12 with warm air wherein inflating the pillow 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An inflatable pillow decoration assembly configured for embellishing a room, the inflatable pillow decoration device comprising:
a pillow having an exterior wall enclosing an interior space, said interior space being in fluid communication with an opening extending through said exterior wall of said pillow, said exterior wall further comprising:
an inner layer bounding said interior space;
a middle layer being positioned on said inner surface and being resiliently compressible; and
an outer layer being coupled to said middle layer; and
an inflation apparatus being positioned in said opening and being in fluid communication with said interior space, said inflation apparatus being configured to inflate said interior space, said inflation apparatus being configured to warm air being supplied to said interior space by said inflation apparatus.

2. The inflatable pillow decoration device of claim 1, further including said inner layer comprising a heat resistant material.

3. The inflatable pillow decoration device of claim 1, further including an air compressor being in fluid communication with said interior of said pillow.

4. The inflatable pillow decoration device of claim 1, further including a heating source being in thermal communication with an air conduit of said air compressor.

5. The inflatable pillow decoration device of claim 1, further including a thermostat being electrically coupled to said heating source and being adjustable to select a temperature of the air positioned in said interior space.

6. The inflatable pillow decoration device of claim 1, further including a power supply being electrically coupled to said air compressor and said heating source.

7. The inflatable pillow decoration device of claim 1, further including said plurality of lights being in electric communication with said power supply.

8. An inflatable pillow decoration assembly configured for embellishing a room, the inflatable pillow decoration device comprising:
a pillow having an exterior wall enclosing an interior space, said interior space being in fluid communication with an opening extending through said exterior wall of said pillow, said exterior wall further comprising:
an inner layer bounding said interior space, said inner layer comprising a heat resistant material;
a middle layer being positioned on said inner surface and being resiliently compressible; and
an outer layer being coupled to said middle layer;
an inflation apparatus being positioned in said opening and being in fluid communication with said interior space, said inflation apparatus being configured to inflate said interior space, said inflation apparatus being configured to warm air being supplied to said interior space by said inflation apparatus, said inflation apparatus including:
an air compressor being in fluid communication with said interior of said pillow;
a heating source being in thermal communication with an air conduit of said air compressor;
a thermostat being electrically coupled to said heating source and being adjustable to select a temperature of the air positioned in said interior space; and
a power supply being electrically coupled to said air compressor and said heating source.
